(19) United States
(12) Patent Application Publication
(10) Pub. No.: US 2003/0136524 A1
(43) Pub. Date: Jul. 24, 2003

(54) Decorative valance

(76) Inventor: Martha Irvine, Mitchellville, MD (US)

Correspondence Address: Ira J. Schultz, DENNISON, SCHULTZ & DOUGHERTY, Suite 612, 1745 Jefferson Davis Highway, Arlington, VA, 22202, US

(21) Appl. No.: 10/338,844

(22) Filed: Jan. 9, 2003

Related U.S. Application Data
(60) Provisional application No. 60/349,269, filed on Jan. 18, 2002.

(51) Int. Cl. E06B 9/00

(52) U.S. Cl. 160/38

(57) ABSTRACT

A decorative valance for hanging on a wall includes a longitudinally extending heading having a plurality of holes along the length thereof extending through the heading, and a swag made up of a plurality of chains hung from the holes to create a desired design. The heading has sufficient stiffness to carry the swag without deformation of the heading.

### BACKGROUND OF THE INVENTION

The invention is in the field of window decorations, and in particular, a decorative valance.

A valance is a fixture typically mounted on the top of a window in order to hide the top of the window, and especially the curtain hardware. A valance includes a heading portion, typically a fabric covering on wood or a stiffening material known as backram, and may include a swag of fabric hanging from the heading. The manufacture and attachment of the swag typically requires a considerable amount of sewing.

### SUMMARY OF THE INVENTION

It is therefore an object of the invention to provide a valance and swag which can be easily constructed and which provides a novel decorative effect.

To achieve these and other objects, the invention is directed to a valance comprising a heading having a plurality of horizontally arranged holes extending therethrough, and a swag comprising chains hanging from the holes in a desired pattern which may be easily changed by varying the type of chain and the manner in which the chains are hung. The valance of the invention may be hung above a window in the ordinary manner and is also adaptable to a commercial environment where it might be mounted above a door or other opening.

### BRIEF DESCRIPTION OF THE DRAWINGS

FIG. 1 is a plan view of the valance of the invention hung above a curtained window; and

FIG. 2 is an enlarged section of the valance shown in FIG. 1.

### DESCRIPTION OF THE PREFERRED EMBODIMENTS

As shown in the figures, a valance 10 includes a heading 12 made of fabric covering backram, or any other material which renders the fabric sufficiently stiff to hold the weight of the swag to be hung therefrom without deformation of the heading. A plurality of holes 14 have been made through the heading, the holes being made in a level straight line, parallel to the edges of the heading; however, the pattern of the holes may be varied to achieve any desired effect, such as holes placed in two or more rows or holes clustered in groups along the length of the heading.

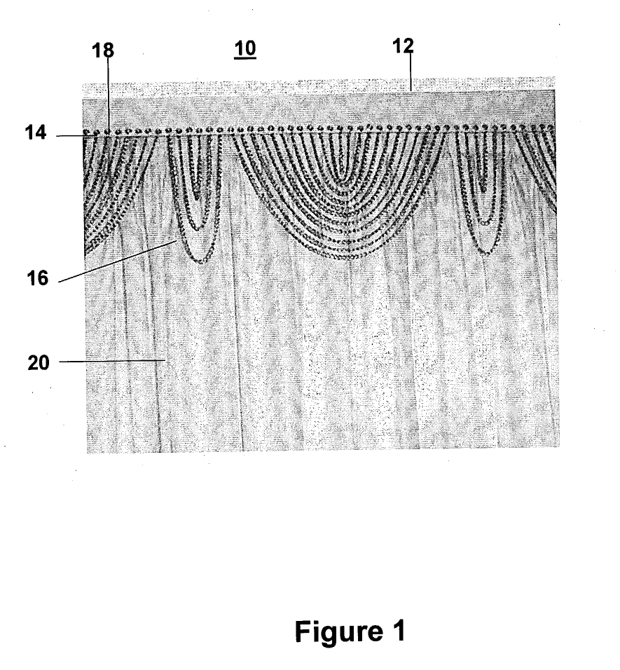

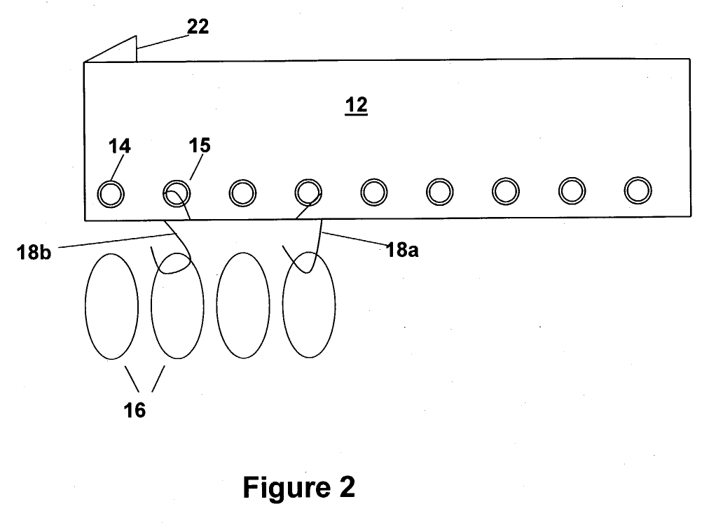

To strengthen the holes, a grommet 15 is placed in each. A chain 16 is hung from each hole and as shown in FIG. 1, each chain is hung between two holes. In an alternative embodiment, each chain may be hung from only one hole, or a hole may accept more than one chain depending on the desired design. The chains may be hung from an open link 18a of the chain 14, or may be hung from a hook 18b, both shown in FIG. 2. In FIG. 1, the valance is hung above a curtained window 20.

The manner of hanging the valance may be any known in the art; typically, side pieces are hung perpendicular to the wall adjacent the window, and the valance hung from the side pieces. The side pieces may also be a part of the valance and the side pieces hung on hooks on the wall. Such a side piece 22 is shown in FIG. 2.

The chains used will typically be metal chains, but can be of any other material, including plastic or fabric.

What is claimed is:

1. A decorative valance for hanging on a wall, comprising:
a longitudinally extending heading having a plurality of holes along the length thereof extending through the heading; and
a swag comprising a plurality of chains hung from the holes to create a desired design,
the heading having sufficient stiffness to carry the swag without deformation of the heading.

2. The valance of claim 1, wherein each of the chains is hung between two holes.

3. The valance of claim 1, wherein each of the holes comprises a grommet mounted therein.

4. The valance of claim 1, additionally comprising hooks secured in the holes from which the chains are hung.

5. The valance of claim 1, additionally comprising chains with an open link secured in the holes, from which the chains are hung.

6. The valance of claim 1, wherein the heading comprises a fabric covered stiffening element.

7. The valance of claim 1, additionally comprising means for attaching the valance to a wall for hanging.

8. The valence of claim 1, wherein the holes are arranged substantially in a straight line.
